(19) United States
(12) Patent Application Publication
(10) Pub. No.: US 2022/0372391 A1
(43) Pub. Date: Nov. 24, 2022

(54) METHOD FOR APPLYING A COATING ONTO A NON-SILICONE HYDROGEL LENS

(71) Applicant: Alcon Inc., Fribourg (CH)

(72) Inventors: Chung-Yuan Chiang, Johns Creek, GA (US); Yongxing Qiu, Suwanee, GA (US)

(21) Appl. No.: 17/659,972

(22) Filed: Apr. 20, 2022

Related U.S. Application Data
(60) Provisional application No. 63/178,132, filed on Apr. 22, 2021.

(51) Int. Cl. C10M 107/42; B29D 11/00; C08J 7/04; C08J 3/24; C10M 107/28; C10M 107/48; G02C 7/04

(52) U.S. Cl. CPC C10M 107/42; B29D 11/00865; C08J 7/0427; C08J 3/245; C10M 107/28; C10M 107/48; G02C 7/04; B29K 2105/0061

(57) ABSTRACT

The present invention generally relates to a method for applying a coating of hydrophilic polymers onto polyvinylalcohol-based hydrogel contact lenses to improve lubricity. In particular, the present invention is directed to a method for forming a coating on a contact lens, preferably a polyvinylalcohol-based hydrogel contact lens, directly in the primary package and maintaining the coated contact lens within said primary package until insertion of the coated contact lens in the eye of the contact lens user. The resultant polyvinylalcohol-based hydrogel contact lens has a coating with improved lubricity and good durability and also can be used directly from the lens package by a patient without washing and/or rinsing.

The present invention generally relates to a method for applying a coating of hydrophilic polymers onto a non-silicone hydrogel contact lenses, preferably polyvinylalcohol-based (i.e., PVA-based) hydrogel contact lenses to improve lubricity. In particular, the present invention is directed to a method for forming a coating on a polyvinylalcohol-based (i.e., PVA-based) contact lenses, directly in the primary package and maintaining the coated contact lens within said primary package until insertion of the coated contact lens in the eye of the contact lens user.

### BACKGROUND OF THE INVENTION

A silicone hydrogel material typically has a surface or at least some areas of its surface which is hydrophobic (non-wettable). Lipids or proteins from the ocular environment can be adsorbed onto hydrophobic surface or surface areas of a silicone hydrogel contact lens. The hydrophobic surface or surface areas of a silicone hydrogel contact lens may cause it be adhered to the eye. Thus, a silicone hydrogel contact lens will generally require a surface modification to increase surface hydrophilicity.

A known method for modifying the hydrophilicity and lubricity of a relatively hydrophobic contact lens material is to attach hydrophilic polymers onto silicone contact lenses according to various mechanisms (see for example, U.S. Pat. Nos. 6,099,122, 6,436,481, 6,440,571, 6,447,920, 6,465,056, 6,521,352, 6,586,038, 6,623,747, 6,730,366, 6,734,321, 6,835,410, 6,878,399, 6,923,978, 6,440,571, 6,500,481, and 9,575,332, US Patent Application Publication Nos. 2009/0145086 A1, 2009/0145091A1, 2008/0142038A1, and 2007/0122540A1, all of which are herein incorporated by reference in their entireties. Although those techniques can be used in rendering a silicone hydrogel material hydrophilicity and lubricity, they may not be cost-effective and/or time-efficient for implementation in a mass production environment for a non-silicone hydrogel material.

Therefore, there are still needs for a new non-silicone hydrogel contact lens having a superior surface lubricity and hydrophilicity for a method capable of producing such contact lenses.

### SUMMARY OF THE INVENTION

The invention, in one aspect, provides a method for applying an ophthalmic product having
a lubricious surface, comprising the steps of:
(1) obtaining a polyvinylalcohol-based hydrogel contact lens,
(2) placing the polyvinylalcohol-based hydrogel contact lens in a lens package containing an in-package-coating solution, wherein the in-package-coating solution comprises:
   (A) a polyanionic polymer having carboxyl groups,
   (B) at least one water-soluble and thermally-crosslinkable polymeric material comprising azetidinium groups,
   (C) at least one decomposable-at-autoclave material, wherein the in-package-coating solution has a pH of from about 1.0 to about 4.0, provided that the molar charge ratio of the polyanionic polymer and the water-soluble and thermal-crosslinkable polymeric material comprising azetidinium groups is from 1:100 to 100:1 and no precipitation is formed after mixings, wherein the polyanionic polymer attaching and forming at least one layer coating on the surface of the polyvinylalcohol-based hydrogel contact lens,
(3) sealing the lens package with the contact lens and the in-package-coating solution having the pH of from about 1.0 to about 4.0,
(4) autoclaving said package with the contact lens and the in-package-coating solution therein, thereby inducing crosslinking reaction between azetidinium groups of the water-soluble polymeric material and the carboxyl groups of the polyanionic polymer to form a crosslinked hydrophilic coating on the surface of the polyvinylalcohol-based hydrogel contact lens immersed in the in-package-coating solution, wherein the decomposable-at-autoclave material is hydrolyzed to increase the pH to 6.5 to 7.5, wherein the polyvinylalcohol-based hydrogel contact lens with the crosslinked hydrophilic coating thereon forms a surface having improved lubricity as compared to uncoated lenses.
In another aspect, this invention provides a method for applying an ophthalmic product having a lubricious surface, comprising the steps of:
(1) obtaining a polyvinylalcohol-based hydrogel contact lens,
(2) placing the polyvinylalcohol-based hydrogel contact in a lens package containing an polyanionic polymer solution for more than 10 seconds to form a layer of the polyanionic polymer coating on the hydrogel contact lens, wherein the polyanionic polymer having carboxyl groups and the solution having a pH of 1.0 to 4.0, and then
(3) adding a water-soluble and thermal-crosslinkable polymeric material comprising azetidinium groups to the lens package of the step (2) containing the polyanionic polymer solution to form an in-package-coating solution, provided that the molar charge ratio of the polyanionic polymer and the water-soluble and thermal-crosslinkable polymeric material comprising azetidinium groups is from 1:100 to 100:1 and no precipitation is formed after mixing, wherein the in-package-coating solution having a pH higher than 6,
(4) sealing the lens package with the contact lens and the in-package-coating solution,
(5) autoclaving said package with the contact lens and the in-package-coating solution therein, thereby inducing crosslinking reaction between azetidinium groups of the water-soluble and thermal-crosslinkable polymeric material and the carboxyl groups of the polyanionic polymer to form an in-package crosslinked hydrophilic coating on the surface of the polyvinylalcohol-based hydrogel contact lens, wherein the polyvinylalcohol-based hydrogel contact lens with the crosslinked hydrophilic coating thereon forms a surface having improved lubricity as compared to uncoated lenses.

These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### DETAILED DESCRIPTION OF EMBODIMENTS OF THE INVENTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens. A “silicone hydrogel contact lens” refers to a contact lens comprising a silicone hydrogel material.

A “hydrogel” refers to a polymeric material which can absorb at least 10 percent by weight of water when it is fully hydrated.

A “silicone hydrogel” refers to a silicone-containing hydrogel obtained by copolymerization of a polymerizable composition comprising at least one silicone-containing monomer or at least one silicone-containing macromer or at least one crosslinkable silicone-containing prepolymer.

A “non-silicone hydrogel” refers to a hydrogel obtained by copolymerization of a polymerizable composition not comprising at least one silicone-containing monomer or at least one silicone-containing macromer or at least one crosslinkable silicone-containing prepolymer.

“Hydrophilic” as used herein, describes a material or portion thereof that will more readily associate with water than with lipids.

A “monomer” means a low molecular weight compound that includes an actinically-crosslinkable group and can be polymerized actinically or thermally. Low molecular weight typically means average molecular weights less than 700 Daltons.

An “actinically-crosslinkable group” refers to a group which can react with another group of same type or different type to form a covalent linkage upon actinic irradiation. Examples of actinically-crosslinkable groups include without limitation ethylenically unsaturated groups, thiol groups, ene-containing groups. Ethylenically unsaturated groups can undergo free-radical chain reaction upon actinic irradiation. Thiol groups (—SH) and ene-containing groups can participate in thiol-ene step-growth radical polymerization as described in a commonly-owned copending U.S. patent application No. 60/869,812 filed Dec. 13, 2006 (entitled “PRODUCTION OF OPHTHALMIC DEVICES BASED ON PHOTO-INDUCED STEP GROWTH POLYMERIZATION”, herein incorporated in reference in its entirety.

As used herein, “actinically” in reference to curing or polymerizing of a polymerizable composition or material means that the curing (e.g., crosslinked and/or polymerized) is performed by actinic irradiation, such as, for example, UV irradiation, ionized radiation (e.g. gamma ray or X-ray irradiation), microwave irradiation, and the like. Thermal curing or actinic curing methods are well-known to a person skilled in the art.

The term “ethylenically unsaturated group” is employed herein in a broad sense and is intended to encompass any groups containing at least one >C═C<group. Exemplary ethylenically unsaturated groups include without limitation (meth)acryloyl

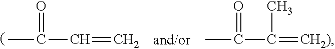

allyl, vinyl (—CH═CH₂), 1-methylethenyl

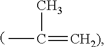

styrenyl, or the likes.

The term “(meth)acrylamide” refers to methacrylamide and/or acrylamide.

The term “(meth)acrylate” refers to methacrylate and/or acrylate.

A “hydrophilic vinylic monomer”, as used herein, refers to a vinylic monomer which can be polymerized to form a homopolymer that is water-soluble or can absorb at least 10 percent by weight of water.

A “hydrophobic vinylic monomer” refers to a vinylic monomer which can be polymerized to form a homopolymer that is insoluble in water and can absorb less than 10 percent by weight of water.

As used in this application, the term “macromer” or “prepolymer” refers to a medium and high molecular weight compound or polymer that contains two or more ethylenically unsaturated groups. Medium and high molecular weight typically means average molecular weights greater than 700 Daltons.

As used in this application, the term “vinylic crosslinker” refers to a compound having at least two ethylenically unsaturated groups. A “vinylic crosslinking agent” refers to a vinylic crosslinker having a molecular weight of about 700 Daltons or less.

As used in this application, the term “polymer” means a material formed by polymerizing/crosslinking one or more monomers or macromers or prepolymers.

As used in this application, the term “molecular weight” of a polymeric material (including monomeric or macromeric materials) refers to the weight-average molecular weight unless otherwise specifically noted or unless testing conditions indicate otherwise.

The term “alkyl” refers to a monovalent radical obtained by removing a hydrogen atom from a linear or branched alkane compound. An alkyl group (radical) forms one bond with one other group in an organic compound.

An “epichlorohydrin-functionalized polyamine” or “epichlorohydrin-functionalized polyamidoamine” refers to a polymer obtained by reacting a polyamine or polyamidoamine with epichlorohydrin to convert all or a substantial percentage of amine groups of the polyamine or polyamidoamine into azetidinium groups.

An “azetidinium group” refers to a positively charged group of

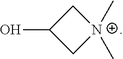

The term “thermally-crosslinkable” in reference to a polymeric material or a functional group means that the polymeric material or the functional group can undergo a crosslinking (or coupling) reaction with another material or functional group at a relatively-elevated temperature (from about 40° C. to about 140° C.), whereas the polymeric material or functional group cannot undergo the same crosslinking reaction (or coupling reaction) with another material or functional group at room temperature (i.e., from about 22° C. to about 28° C., preferably from about 24° C. to about 26° C., in particular at about 25° C.) to an extend detectable for a period of about one hour.

The term “reactive vinylic monomer” refers to a vinylic monomer having a carboxyl group or an amino group (i.e., a primary or secondary amino group).

The term “water-soluble” in reference to a polymer means that the polymer can be dissolved in water to an extent sufficient to form an aqueous solution of the polymer having a concentration of up to about 30% by weight at room temperature (defined above).

A “water contact angle” refers to an average water contact angle (i.e., contact angles measured by Sessile Drop method), which is obtained by averaging measurements of contact angles with at least 3 individual contact lenses.

As used herein, a “polyanionic material” refers to a polymeric material that has a plurality of negative charged groups or ionizable groups.

A “hydrophilic surface” in reference to a contact lens means that the hydrogel material or the contact lens has a surface hydrophilicity characterized by having an averaged water contact angle of about 90 degrees or less, preferably about 80 degrees or less, more preferably about 70 degrees or less, more preferably about 60 degrees or less.

An “average contact angle” refers to a water contact angle (measured by Sessile Drop method), which is obtained by averaging measurements of at least three individual contact lenses.

As used herein, “increased surface hydrophilicity” or “increased hydrophilicity” in reference to a contact lens means that the contact lens autoclaved in a packaging solution of the invention has a smaller averaged (water) contact angle relative to that of a control contact lens autoclaved in a buffered saline packaging solution without water-soluble and thermal-crosslinkable polymeric, a polyanionic material and at least one hydrolysable-at-autoclave material, wherein all contact lenses are made of the same core material.

The term “intactness” in reference to a coating on a hydrogel contact lens is intended to describe the extent to which the contact lens can be stained by Sudan Black in a Sudan Black staining test described in Example 1. Good intactness of the coating on a hydrogel contact lens means that there is practically no Sudan Black staining of the contact lens.

The term “durability” in reference to a coating on a hydrogel contact lens is intended to describe that the coating on the hydrogel contact lens can survive a digital rubbing test.

As used herein, “surviving a digital rubbing test” in reference to a coating on a contact lens means that after digitally rubbing the lens with Solo-Care® (CIBA Vision) or an equivalent, there is no noticeable increase in staining area on the lens relative to the staining of a lens of same without rubbing, as described in Example 1. In accordance with the invention, a hydrogel contact lens of the invention has a coating that is capable of surviving preferably at least 5, more preferably at least 10, even more preferably at least 20 consecutive digital rubbing tests.

As used herein, the term “a neutral pH” in reference to a solution means that the pH of the solution is from about 6.0 to about 8.0.

In general, the invention is directed to a cost-effective surface treatment method for making non-silicone hydrophilic hydrogel contact lenses with improved lubricity coatings. The invention is partly based on the discovery that when decomposable-at-autoclave material (i.e., hydrolysable-at-autoclave materials), for example, such as, urea, ammonium carbamate, ester (e.g., polyvinyl acetate), or anhydride, is added into a lens packaging solution, they can be hydrolyzed during autoclave process (i.e., sterilization of the lens packages). The hydrolysis products of such material can change the pH of the packaging solution from a low or high value to a neutral value (e.g., around pH=7). As such, the initial (prior to autoclave) and final (posterior autoclave) pH values of a lens packaging solution can be controlled as one desires.

The invention is also partly based on the discovery that a lubricious coating can be applied onto a non-silicone hydrophilic hydrogel contact lens, preferably polyvinylalcohol-based (i.e., PVA-based) hydrogel contact lenses, in situ, directly in a lens package containing a lens packaging solution including a decomposable-at-autoclave material (hydrolysable-at-autoclave material) and under optimal coating conditions for forming a coating with good lubricity, intactness and durability on a non-silicone hydrophilic hydrogel contact lens, preferably polyvinylalcohol-based (i.e., PVA-based) hydrogel contact lenses.

The invention is further partly based on the discovery that a lubricious coating can be applied onto a non-silicone hydrogel contact lens, preferably polyvinylalcohol-based (i.e., PVA-based) hydrogel contact lenses, in situ, directly in a lens package containing a lens packaging solution comprising (A) a polyanionic polymer having carboxyl groups, (B) at least one water-soluble polymeric material comprising azetidinium groups, (C) at least one decomposable-at-autoclave material, and under optimal coating conditions for forming an lubricious and wettable coating with good intactness and durability on a polyvinylalcohol-based (i.e., PVA-based) hydrogel contact lens.

It is known that through hydrophobic-hydrophobic interaction, the hydrophobic backbone of a coating material may strongly interact with the hydrophobic surface areas of a silicone hydrogel contact lens to anchor the coating material onto the lens surface. At extreme pH, e.g., at low pH, the ionizable groups of a polyanionic material may not be ionized and the hydrophobic backbone of the polyanionic material may have the strongest interaction with the hydrophobic surface areas of a silicone hydrogel contact lens. The water-soluble, azetidinium-containing polymeric material is thermally-crosslinkable (reactive) due to the presence of azetidinium groups with carboxyl groups of the polyanionic material which is introduced to the hydrophobic surface areas of a silicone hydrogel contact lens to form a crosslinked coating on a silicone hydrogel contact lens as shown in U.S. Pat. No. 9,575,332 B2, herein incorporated by reference in its entirety.

It is surprised to find out that the hydrophobic backbone of a coating material may also strongly interact with the surface areas of a highly hydrophilic polyvinylalcohol-based (i.e., PVA-based) hydrogel contact lenses to anchor the coating material onto the lens surface. At extreme pH, e.g., at low pH, the water-soluble, azetidinium-containing polymeric material is thermally-crosslinkable (reactive) due to the presence of azetidinium groups with carboxyl groups of the polyanionic material which is introduced to the surface areas of a highly hydrophilic polyvinylalcohol-based (i.e., PVA-based) hydrogel contact lenses to form a crosslinked coating on a highly hydrophilic polyvinylalcohol-based (i.e., PVA-based) hydrogel contact lenses. Due to its high number of alcoholic groups, polyvinyl alcohol is one of the most polar and hydrophilic synthetic polymers that can also form hydrogels. For example, the commercial available polyvinylalcohol-based (i.e., PVA-based) hydrogel contact lenses has a water contact angle of about 21 and water content of about 72%.

Contact lenses, which are hydrated and packaged in solution, must be sterilized. Sterilization of the hydrated lenses during manufacturing and packaging is typically accomplished by autoclaving. The autoclaving process involves heating the packaging of a contact lens to a temperature of about 121° C. for approximately 20-30 minutes under pressure. Since contact lenses in the lens packages typically need to be sterilized by autoclave at about 121° C., an in situ lubricious coating of a polyvinylalcohol-based (i.e., PVA-based) hydrogel contact lenses can be carried out at high temperature and at extreme pH (at least for the first several minutes of autoclave). It is discovered that, by incorporating in the lens packaging solution a hydrolysable-at-autoclave material which can produce base or acid during hydrolysis process, the final pH of the packaging solution can be automatically adjusted to a neutral pH value after autoclave. By using the method of the invention, the coating process is combined with the sterilization step (autoclave) in the manufacturing of polyvinylalcohol-based (i.e., PVA-based) hydrogel contact lenses. No prior surface treatment is needed. The resultant contact lenses not only can have a surface having high lubricity and good intactness and durability, but also can be used directly from the lens package by a patient without washing and/or rising because of the neutral pH and adequate tonicity of the packaging solution.

As used herein, an “in situ lubricious coating process” is intended to describe a process in which a lubricious coating is applied onto a contact lens directly in a lens package which is supplied to a customer. Any lens packages known to a person skilled in the art can be used in the invention.

It is believed that during autoclave those azetidinium groups which do not participate in crosslinking reaction may be hydrolyzed into 2, 3-dihydroxypropyl (HO—CH₂—CH(OH)—CH₂—) groups and that the azetidinium-containing polymeric material present in the lens packaging solution, if applicable, can be converted to a non-reactive polymeric wetting material.

By using the method of the invention, the coating process can be combined with the sterilization step (autoclave) in the manufacturing of polyvinylalcohol-based (i.e., PVA-based) hydrogel contact lenses. The resultant contact lenses not only can have an improved lubricity, good intactness, and good durability, but also can be used directly from the lens package by a patient without washing and/or rising because of the ophthalmic compatibility of the packaging solution.

The invention is generally directed to a cost-effective and time-efficient method for making s polyvinylalcohol-based (i.e., PVA-based) hydrogel contact lenses with lubricious coatings by use of a water-soluble and thermally-crosslinkable hydrophilic polymeric material having azetidinium groups.
The invention, in one aspect, provides a method for applying an ophthalmic product having a lubricious surface, comprising the steps of:
   (1) obtaining a polyvinylalcohol-based hydrogel contact lens,
   (2) placing the polyvinylalcohol-based hydrogel contact lens in a lens package containing an in-package-coating solution, wherein the in-package-coating solution comprises:
      (A) a polyanionic polymer having carboxyl groups,
      (B) at least one water-soluble and thermally-crosslinkable polymeric material comprising azetidinium groups,
      (C) at least one decomposable-at-autoclave material, wherein the in-package-coating solution has a pH of from about 1.0 to about 4.0, provided that the molar charge ratio of the polyanionic polymer and the water-soluble and thermal-crosslinkable polymeric material comprising azetidinium groups is from 1:100 to 100:1 and no precipitation is formed after mixings, wherein the polyanionic polymer attaching and forming at least one layer coating on the surface of the polyvinylalcohol-based hydrogel contact lens,
   (3) sealing the lens package with the contact lens and the in-package-coating solution having the pH of from about 1.0 to about 4.0,
   (4) autoclaving said package with the contact lens and the in-package-coating solution therein, thereby inducing crosslinking reaction between azetidinium groups of the water-soluble polymeric material and the carboxyl groups of the polyanionic polymer to form a crosslinked hydrophilic coating on the surface of the polyvinylalcohol-based hydrogel contact lens immersed in the in-package-coating solution, wherein the decomposable-at-autoclave material is hydrolyzed to increase the pH to 6.5 to 7.5, wherein the polyvinylalcohol-based hydrogel contact lens with the crosslinked hydrophilic coating thereon has a surface having improved lubricity as compared to uncoated lenses.

In accordance with the invention, the packaging solution is an aqueous solution which is ophthalmically safe. The term “ophthalmically safe” with respect to an aqueous solution for sterilizing and storing contact lenses is meant that a contact lens stored in the solution is safe for direct placement on the eye without rinsing, that is, the solution is safe and sufficiently comfortable for daily contact with the eye via a contact lens. An ophthalmically safe solution has a tonicity and pH that is compatible with the eye and comprises materials, and amounts thereof, that are non-cytotoxic according to international ISO standards and U.S. FDA regulations.

The term “compatible with the eye” means a solution that may be in intimate contact with the eye for an extended period of time without significantly damaging the eye and without significant user discomfort.

A variety of packages can be used to store contact lenses, including for example, vials, blister packages or equivalents. In particular, so-called blister packages are widely used for the storage and dispensing of the contact lenses. Typically, the blister package for storing and dispensing a contact lens includes an injection-molded or thermoformed plastic base portion incorporating a molded cavity which is surrounded by an outstanding planar flange about the rim of the cavity. The plastic base portion is made of plastic material. A flexible cover sheet is adhered to the surface of the flange so as to seal or enclose the cavity in a generally liquid-tight mode. Within the cavity of the base portion, a contact lens is immersed in a sterile aqueous solution, such as an isotonic saline solution.

The base portion may be formed from a variety of plastic materials, but is preferably transparent to allow the user to inspect the lens without opening the storage package. The plastic material should be capable of being sterilized at 120° C. without substantial loss of its physical properties of dimensional stability, warpage, and shrinkage. The plastic material should have low water and vapor permeability to prevent the evaporation and loss of the lens care solution. The plastic material should not be permeable to bacteria and oxygen in order to avoid contamination and to keep the efficacy of the solution. Preferably, plastic materials should have a high strength and a high tolerance, in view of the cost and efficiency in manufacturing the base portion and easiness in handling the material.

Examples of plastic materials include without limitation fluoro-resin, polyamide, polyacrylate, polyethylene, nylons, olefin co-polymers (e.g., copolymers of polypropylene and polyethylene), polyethylene terephthalate, poly vinyl chloride, non-crystalline polyolefin, polycarbonate, polysulfone, polybutylene terephthalate, polypropylene, polymethyl pentene, polyesters, rubbers, urethanes, and the like. These materials are adopted solely or alternatively in a composite body or a laminar structure. The plastic material used to make the base is preferably polypropylene.

The base portion is preferably prepared by injection molding or thermoforming and. may be in any desired forms.

The cavity of the base portion may be suitably designed and sized with no limitation to receive the lens and the sufficient quantity of sterile preserving solution to completely submerge the lens. The cavity may have a variety of shapes in plane view, including a circular shape, a polygonal shape, an ellipsoidal shape, a heart shape, and the like. The surface of the cavity may be desirably shaped depending upon a specific configuration, size and the like of an ophthalmic lens to be received in the cavity. For instance, the surface of the cavity may have a hemisphere (concave) shape.

In accordance with the present invention, at least the surface of the cavity of a base portion is modified by surface treatment. The surface treatment can be performed by a variety of methods, including without limitation plasma treatment, plasma coating, corona discharge, LbL coating, flame treatment and acid surface etching treatment. Preferably, the surface treatment is corona discharge, plasma treatment, or LbL coating.

Typically, the base comprises a flange portion extending about the cavity containing a soft contact lens in a sterile packaging solution, so as to ensure that at least the cavity is appropriately sealed by a flexible cover sheet.

The cover sheet may be a single film or alternatively a multi-layered film and any film may be adopted as the cover sheet as long as the film is capable of being sealed to the container base by bonding, welding or other similar methods. The flexible cover sheet may be formed of a variety of water-impermeable materials and may have a variety of thicknesses. The sheet must be sufficiently flexible to enable the user to easily remove the sheet from the base portion. The cover sheet is preferably a laminate material preferably comprising a metal foil layer and at least one, preferably two polymer layers, e.g. polypropylene, coating the foil. The preferred foil is aluminum. Preferably, the sheet is formed from a metal (e.g., aluminum) foil or foil composite.

The cover sheet may be printed with information regarding the contact lens contained in the package or with other information for the end user or the dealer. The base may be affixed to the flexible cover sheet by a number of methods. However, the strength of the bond between the base and sheet should not be excessive, i.e., the user should be able to easily and quickly separate the sheet from the base. For example, the cover sheet can be sealed to the base or flange thereof by means of temperature or ultrasonic treatment or by another appropriate adhesion method.

It should be understood that a plurality of base parts, e.g., four base parts, advantageously form one unit, so that handling of the base parts in the manufacturing process is simplified.

According to the present application, any suitable polyvinylalcohol-based hydrogel contact lenses can be used in the invention, preferably, they are composed of a polymer comprising at least 50% by mole (more preferably at least 60% by mole, even more preferably at least 70% by mole, further more preferably at least 75% by mole of repeating units of vinyl alcohol.

For production of hydrogel contact lenses, a hydrogel lens formulation typically is: either (1) a monomer mixture comprising (a) at least one hydrophilic vinylic monomer (e.g., hydroxyethyl methacrylate, glycerol methacrylate, N-vinylpyrrolidone, or combinations thereof) and (b) at least one component selected from the group consisting of a crosslinking agent, a hydrophobic vinylic monomer, a lubricating agent (or so-called internal wetting agents incorporated in a lens formulation), a free-radical initiator (photoinitiator or thermal initiator), a UV-absorbing agent, a visibility tinting agent (e.g., dyes, pigments, or mixtures thereof), antimicrobial agents (e.g., preferably silver nanoparticles), a bioactive agent, and combinations thereof; or (2) an aqueous solution comprising one or more water-soluble prepolymers and at least one component selected from the group consisting of hydrophilic vinylic monomer, a crosslinking agent, a hydrophobic vinylic monomer, a lubricating agent (or so-called internal wetting agents incorporated in a lens formulation), a free-radical initiator (photoinitiator or thermal initiator), a UV-absorbing agent, a visibility tinting agent (e.g., dyes, pigments, or mixtures thereof), antimicrobial agents (e.g., preferably silver nanoparticles), a bioactive agent, and combinations thereof. Resultant preformed hydrogel contact lenses then can be subjected to extraction with an extraction solvent to remove unpolymerized components from the resultant lenses and to hydration process, as known by a person skilled in the art.

In a preferred embodiment, a preformed polyvinylalcohol-based hydrogel contact lens is preferably obtained by polymerizing a water-soluble, actinically-crosslinkable polyvinyl alcohol prepolymer, comprising:
repeating units of vinyl alcohol

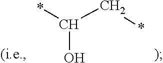

repeating crosslinking units of formula (I); and

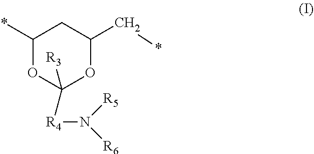

in which:
R₃ can be hydrogen or a C₁-C₆ alkyl group (preferably hydrogen);
R₄ is a C₁-C₆ alkylene divalent radical (preferably a C₁-C₄ alkylene divalent radical, more preferably methylene or butylene divalent radical, even more preferably methylene divalent radical);
R₅ is hydrogen or C₁-C₆ alkyl (preferably hydrogen or C₁-C₄ alkyl, more preferably hydrogen or methyl or ethyl, even more preferably hydrogen or methyl);
R₆ is an ethylenically unsaturated group of

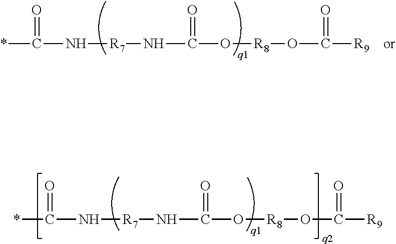

in which q1 and q2 independently of each another are zero or one, and R₇ and R₈ independently of one another are a C₂-C₈ alkylene divalent radical, R₉ is C₂-C₈ alkenyl.

In another preferred embodiment, wherein R₄ is methylene divalent radical, R₅ is hydrogen or C₁-C₄ alkyl, R₃ is hydrogen, and R₆ is a radical of

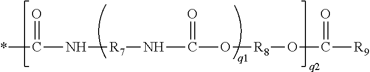

in which q2 is zero, R₉ is vinyl (*—CH═CH₂) or 1-methylethenyl (*—C(CH₃)═CH₂).

In another preferred embodiment, the polyvinylalcohol prepolymer has a weight average molecular weight of at least about 2,000 Daltons, and comprises from about 1% to about 25% by mole, preferably from about 2% to about 15% by mole of the repeating units of formula (I).

A water-soluble, actinically-crosslinkable polyvinylalcohol prepolymer can be prepared using techniques known in the art, e.g., those disclosed in U.S. Pat. Nos. 5,583,163 and 6,303,687 (herein incorporated by references in their entireties).

Preferably, the polyvinylalcohol prepolymers are purified in a manner known per se, for example by precipitation with organic solvents, such as acetone, filtration and washing, extraction in a suitable solvent, dialysis or ultrafiltration, ultrafiltration being especially preferred. By means of that purification process the prepolymers can be obtained in extremely pure form, for example in the form of concentrated aqueous solutions that are free, or at least substantially free, from reaction products, such as salts, and from starting materials, such as, for example, non-polymeric constituents.

The preferred purification process for the prepolymers used in the process according to the invention, ultrafiltration, can be carried out in a manner known per se. It is possible for the ultrafiltration to be carried out repeatedly, for example from two to ten times. Alternatively, the ultrafiltration can be carried out continuously until the selected degree of purity is attained. The selected degree of purity can in principle be as high as desired. A suitable measure for the degree of purity is, for example, the concentration of dissolved salts obtained as by-products, which can be determined simply in known manner.

It would be advantageous that the water-soluble actinically-crosslinkable polyvinylalcohol prepolymers are in a substantially pure form (e.g., purified by ultrafiltration to remove most reactants for forming the prepolymer). Therefore, after crosslinking by actinic radiation, a contact lens may require practically no more subsequent purification, such as in particular complicated extraction of unpolymerized constituents. Furthermore, crosslinking may take place in aqueous solution, so that a subsequent solvent exchange or the hydration step is not necessary.

Preferably, a polyvinylalcohol-based hydrogel contact lens is obtained by: introducing an aqueous lens-forming composition including a water-soluble, actinically-crosslinkable polyvinyl alcohol prepolymer described above into a reusable mold and curing under a spatial limitation of actinic radiation the aqueous lens-forming composition.

Preferably, a reusable mold suitable for spatial limitation of radiation is used in the invention, the projected beam of radiation (e.g., radiation from the light source including the light in the region of 360 nm to 550 nm) limits radiation (e.g., UV radiation) impinging on the mixture of the lens-forming materials located in the path of the projected beam from the first molding surface to the second molding surface of the reusable mold. The resultant contact lens comprises an anterior surface defined by the first molding surface, an opposite posterior surface defined by the second molding surface, and a lens edge (with sharp edge and high quality) defined by the sectional profile of the projected radiation beam (i.e., a spatial limitation of radiation). Examples of reusable molds suitable for spatial limitation of radiation include without limitation those disclosed in U.S. Pat. Nos. 6,627,124, 6,800,225, 7,384,590, and 7,387,759, which are incorporated by reference in their entireties.

For example, a preferred reusable mold comprises a first mold half having a first molding surface and a second mold half having a second molding surface. The two mold halves of the preferred reusable mold are not touching each other, but there is a thin gap of annular design arranged between the two mold halves. The gap is connected to the mold cavity formed between the first and second molding surfaces, so that excess mixture can flow into the gap. It is understood that gaps with any design can be used in the invention.

In a preferred embodiment, at least one of the first and second molding surfaces is permeable to a crosslinking radiation. More preferably, one of the first and second molding surfaces is permeable to a crosslinking radiation while the other molding surface is poorly permeable to the crosslinking radiation.

The reusable mold preferably comprises a mask which is fixed, constructed or arranged in, at or on the mold half having the radiation-permeable molding surface. The mask is impermeable or at least of poor permeability compared with the permeability of the radiation-permeable molding surface. The mask extends inwardly right up to the mold cavity and surrounds the mold cavity so as to screen all areas behind the mask with the exception of the mold cavity.

The mask may preferably be a thin chromium layer, which can be produced according to processes as known, for example, in photo and UV lithography. Other metals or metal oxides may also be suitable mask materials. The mask can also be coated with a protective layer, for example of silicon dioxide if the material used for the mold or mold half is quartz.

Alternatively, the mask can be a masking collar made of a material comprising a UV/visible light-absorber and substantially blocks curing energy therethrough as described in U.S. Pat. No. 7,387,759 (incorporated by reference in its entirety). In this preferred embodiment, the mold half with the mask comprises a generally circular disc-shaped transmissive portion and a masking collar having an inner diameter adapted to fit in close engagement with the transmissive portion, wherein said transmissive portion is made from an optically clear material and allows passage of curing energy therethrough, and wherein the masking collar is made from a material comprising a light-blocker and substantially blocks passage of curing energy therethrough, wherein the masking collar generally resembles a washer or a doughnut, with a center hole for receiving the transmissive portion, wherein the transmissive portion is pressed into the center opening of the masking collar and the masking collar is mounted within a bushing sleeve.

Reusable molds can be made of quartz, glass, sapphire, CaF₂, a cyclic olefin copolymer (such as for example, Topas® COC grade 8007-S10 (clear amorphous copolymer of ethylene and norbornene) from Ticona GmbH of Frankfurt, Germany and Summit, N.J., Zeonex® and Zeonor® from Zeon Chemicals LP, Louisville, Ky.), polymethylmethacrylate (PMMA), polyoxymethylene from DuPont (Delrin), Ultem® (polyetherimide) from G.E. Plastics, PrimoSpire®, etc. Because of the reusability of the mold halves, a relatively high outlay can be expended at the time of their production in order to obtain molds of extremely high precision and reproducibility. Since the mold halves do not touch each other in the region of the lens to be produced, i.e. the cavity or actual molding surfaces, damage as a result of contact is ruled out. This ensures a high service life of the molds, which, in particular, also ensures high reproducibility of the contact lenses to be produced and high fidelity to the lens design.

In accordance with the invention, the polyanionic materials that may be employed in the present invention include polyanionic polymers with a hydrophobic backbone and charged or ionizable pendant groups.

Examples of suitable polyanionic polymers include, without limitation a linear polyacrylic acid (PAA), a branched polyacrylic acid, a polymethacrylic acid (PMA), a copolymer of acrylic acid, a copolymer of methacrylic acid, a maleic or fumaric acid copolymer, a poly(styrenesulfonic acid) (PSS). Examples of a branched polyacrylic acid include a Carbophil® or Carbopol® type from Goodrich Corp. Examples of a copolymer of acrylic or methacrylic acid include a copolymerization product of an acrylic or methacrylic acid with a vinyl monomer including, for example, acrylamide, N,N-dimethyl acrylamide or N-vinylpyrrolidone. A preferred polyanionic polymer with a hydrophobic backbone is a polymer containing carboxyl groups (—COOH). It is believed that carboxyl groups can be protonated at a pH of about 1 to about 3. A more preferred polyanionic polymer with a hydrophobic backbone is a linear or branched polyacrylic acid or an acrylic acid copolymer. A more preferred anionic polymer is a linear or branched polyacrylic acid. A branched polyacrylic acid in this context is to be understood to be a polyacrylic acid obtainable by polymerizing acrylic acid in the presence of suitable (minor) amounts of a di- or multi-vinyl compound.

In according with the present invention, a water-soluble, azetidinium-containing, and thermally-crosslinkable hydrophilic polymeric material is a partial reaction product of a polyamine—epichlorohydrin or polyamidoamine—epichlorohydrin with at least one hydrophilicity-enhancing agent having at least one reactive functional group selected from the group consisting of carboxyl group, can be used to form a crosslinked coating with a good surface hydrophilicity and lubricity. At a relatively elevated temperature (defined above), positively-charged azetidinium groups react with functional groups such as amino groups, thiol groups, and carboxylate ion —COO⁻ (i.e., the deprotonated form of a carboxyl group) to form neutral, hydroxyl-containing covalent linkages as illustrated in the scheme I

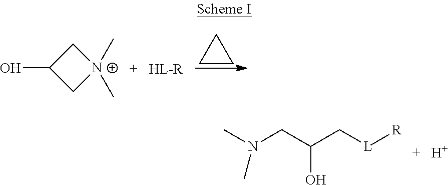

in which R is the rest portion of a compound, L is —NR′— in which R′ is hydrogen, a C₁-C₂₀ unsubstituted or substituted, linear or branched alkyl group or a polymer chain —S—, or —OC(═O)—. Because of the thermally-controllable reactivity of azetidinium groups, polyamine-epichlorohydrin or polyamidoamine—epichlorohydrin (PAE) has been widely used as a wet-strengthening agent. However, PAE has not been successfully used to form crosslinked coatings on contact lenses, probably because crosslinked PAE coatings may not be able to impart desirable hydrophilicity, wettability, and lubricity to contact lenses. It is surprisingly discovered here that PAE can be chemically-modified with a hydrophilicity-enhancing agent (especially a hydrophilic polymer) having one or more functional groups each capable of reacting with one azetidinium group, in a “heat-pretreatment” or “pretreatment” process, to obtain a water-soluble, azetidinium-containing polymeric material. Such polymeric material, which is still thermally-crosslinkable (reactive) due to the presence of azetidinium groups, can be used to form a crosslinked coating on a polyvinylalcohol-based hydrogel contact lens having reactive functional groups (e.g., amino groups, carboxyl groups, thiol groups, or combinations thereof) on and/or near its surface. It is further surprising discovered here that a lubricious coating can be applied onto a polyvinylalcohol-based hydrogel contact lens, in situ, directly in a lens package containing a lens packaging solution comprising (A) a polyanionic polymer having carboxyl groups, (B) at least one reactive-at-autoclave material, such as a water-soluble polymeric material comprising azetidinium groups, (C) at least one decomposable-at-autoclave material, and under optimal coating conditions for forming an lubricious coating with good intactness and durability on a polyvinylalcohol-based hydrogel contact lens.

It is believed that a lubricity and hydrophilicity-enhancing agent may play at least two roles in increasing the performance of resultant crosslinked coatings: adding lubricity and hydrophilicity polymer chains onto a polyamine or polyamidoamine polymer chain to form a highly-branched hydrophilic polymeric material with dangling polymer chains and/or chain segments; and decreasing the crosslinking density of the crosslinked coating by reducing significantly the number of azetidinium groups of the crosslinkable polymeric material (coating material). A coating with a loose structure and dangling polymer chains and/or chain segments is believed to impart a good surface lubricity, hydrophilicity and/or wettability.

In according with the present invention, any suitable lubricity and hydrophilicity-enhancing agents can be used in the invention so long as they contain at least one amino group, at least one carboxyl group, and/or at least one thiol group.

A preferred class of hydrophilic polymers as lubricity and hydrophilicity-enhancing agents include without limitation: a copolymer which is a polymerization product of a composition comprising (1) about 50% by weight or less, preferably from about 0.1% to about 30%, more preferably from about 0.5% to about 20%, even more preferably from about 1% to about 15%, by weight of one or more reactive vinylic monomers and (2) at least one non-reactive hydrophilic vinylic monomer and/or at least one phosphorylcholine-containing vinylic monomer; and combinations thereof. Reactive vinylic monomer(s) and non-reactive hydrophilic vinylic monomer(s) are described below.

Examples of reactive polymers include without limitation: a homopolymer of a reactive vinylic monomer; a copolymer of two or more reactive vinylic monomers; a copolymer of a reactive vinylic monomer with one or more non-reactive hydrophilic vinylic monomers (i.e., hydrophilic vinylic monomers free of any carboxyl or (primary or secondary) amino group).

Examples of preferred reactive polymers are polyacrylic acid, polymethacrylic acid, poly(C₂-C₁₂ alkylacrylic acid), poly[acrylic acid-co-methacrylic acid], poly(N,N-2-acrylamidoglycolic acid), poly[(meth)acrylic acid-co-acrylamide], poly[(meth)acrylic acid-co-vinylpyrrolidone], poly[C₂-C₁₂ alkylacrylic acid-co-acrylamide], poly[C₂-C₁₂ alkylacrylic acid-co-vinylpyrrolidone], hydrolyzed poly[(meth)acrylic acid-co-vinylacetate], hydrolyzed poly[C₂-C₁₂ alkylacrylic acid-co-vinylacetate], polyethyleneimine (PEI), polyallylamine hydrochloride (PAH) homo- or copolymer, polyvinylamine homo- or copolymer, or combinations thereof.

Preferred examples of non-reactive hydrophilic vinylic monomers free of carboxyl or amino group include without limitation acrylamide (AAm), methacrylamide N,N-dimethylacrylamide (DMA), N,N-dimethylmethacrylamide (DMMA), N-vinylpyrrolidone (NVP), N,N,-dimethylaminoethylmethacrylate (DMAEM), N,N-dimethylaminoethylacrylate (DMAEA), N,N-dimethylaminopropylmethacrylamide (DMAPMAm), N,N-dimethylaminopropylacrylamide (DMAPAAm), glycerol methacrylate, 3-acryloylamino-1-propanol, N-hydroxyethyl acrylamide, N-[tris(hydroxymethyl)methyl]-acrylamide, N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 2-hydroxyethyl (meth)acrylate, hydroxypropyl (meth)acrylate, C₁-C₄-alkoxy polyethylene glycol (meth)acrylate having a weight average molecular weight of up to 1500 Daltons, N-vinyl formamide, N-vinyl acetamide, N-vinyl isopropylamide, N-vinyl-N-methyl acetamide, allyl alcohol, vinyl alcohol (hydrolyzed form of vinyl acetate in the copolymer), a phosphorylcholine-containing vinylic monomer (including (meth)acryloyloxyethyl phosphorylcholine and those described in U.S. Pat. No. 5,461,433, herein incorporated by reference in its entirety), and combinations thereof.

In accordance with the invention, the reaction between a lubricity and hydrophilicity-enhancing agent and an epichlorohydrin-functionalized polyamine or polyamidoamine is carried out at a temperature of from about 40° C. to about 100° C. for a period of time sufficient (from about 0.3 hour to about 24 hours, preferably from about 1 hour to about 12 hours, even more preferably from about 2 hours to about 8 hours) to form a water-soluble and thermally-crosslinkable hydrophilic polymeric material containing azetidinium groups.

In accordance with the invention, the concentration of a lubricity and hydrophilicity-enhancing agent relative to an epichlorohydrin-functionalized polyamine or polyamidoamine must be selected not to render a resultant hydrophilic polymeric material water-insoluble (i.e., a solubility of less than 0.005 g per 100 ml of water at room temperature) and not to consume more than about 99%, preferably about 98%, more preferably about 97%, even more preferably about 96% of the azetidinium groups of the epichlorohydrin-functionalized polyamine or polyamidoamine. Products and processes of making the water-soluble and thermal-crosslinkable hydrophilic polymer material containing azetidinium groups and hydrophiliclicity-enhancing agent are disclosed in commonly assigned U.S. Patent application US 2012/0026457 A1, herein incorporated by reference in its entirety.

To control the amount of each polyionic component in an in-package-coating solution, the molar charge ratio can be varied. As used herein, “molar charge ratio” is defined as the ratio of ionic groups or charged functional groups in the solution on a molar basis. For example, a 10:1 molar charge ratio can be defined as 10 charged functional groups of a polyanion to 1 charged functional group of a water-soluble and thermally-crosslinkable polymeric material comprising azetidinium groups (i.e. polycation). The molar charge ratio can be determined as defined above for any number of components within a solution, as long as at least one polycation and one polyanion are included therein. An in-package-coating coating solution typically has a molar charge ratio from 1:100 to 100:1 provided that no precipitation is formed after mixings. The coating solution could have a molar charge ratio of about 20:1 to 1:20 (polyanion:polycation) provided that no precipitation is formed after mixings. The coating solution could have a molar charge ratio of about 1:10 to 10:1 (polyanion:polycation) provided that no precipitation is formed after mixings. In still another example, a 5:1 to 1:5 molar charge ratio may be utilized provided that no precipitation is formed after mixings.

In accordance with the invention, the step of autoclaving is performed preferably by heating the polyvinylalcohol-based hydrogel contact lens immersed in a packaging solution (i.e., a buffered aqueous solution) in a sealed lens package at a temperature of from about 118° C. to about 125° C. for approximately 20-90 minutes. In accordance with this embodiment of the invention, the packaging solution is a buffered aqueous solution which is ophthalmically safe after autoclave.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes) prior to dispensing to users. A person skilled in the art will understand well how to seal and sterilize lens packages.

In accordance with the invention, a packaging solution contains at least one buffering agent and one or more other ingredients known to a person skilled in the art. Examples of other ingredients include without limitation, tonicity agents, surfactants, antibacterial agents, preservatives, and lubricants (or water-soluble viscosity builders) (e.g., cellulose derivatives, polyvinyl alcohol, and polyvinylpyrrolidone).

The packaging solution contains a buffering agent in an amount sufficient to maintain a pH of the packaging solution in the desired range, for example, preferably in a physiologically acceptable range of about 6 to about 8.5. Any known, physiologically compatible buffering agents can be used. Suitable buffering agents as a constituent of the contact lens care composition according to the invention are known to the person skilled in the art. Examples are boric acid, borates, e.g. sodium borate, citric acid, citrates, e.g. potassium citrate, bicarbonates, e.g. sodium bicarbonate, TRIS (2-amino-2-hydroxymethyl-1,3-propanediol), Bis-Tris (Bis-(2-hydroxyethyl)-imino-tris-(hydroxymethyl)-methane), bis-aminopolyols, triethanolamine, ACES (N-(2-hydroxyethyl)-2-aminoethanesulfonic acid), BES (N,N-Bis(2-hydroxyethyl)-2-aminoethanesulfonic acid), HEPES (4-(2-hydroxyethyl)-1-piperazineethanesulfonic acid), MES (2-(N-morpholino)ethanesulfonic acid), MOPS (3-[N-morpholino]-propanesulfonic acid), PIPES (piperazine-N,N′-bis(2-ethanesulfonic acid), TES (N-[Tris(hydroxymethyl)methyl]-2-aminoethanesulfonic acid), salts thereof, phosphate buffers, e.g. Na₂HPO₄, NaH₂PO₄, and KH₂PO₄ or mixtures thereof. A preferred bis-aminopolyol is 1, 3-bis (tris [hydroxymethyl]-methylamino) propane (bis-TRIS-propane). The amount of each buffer agent in a packaging solution is preferably from 0.001% to 2%, preferably from 0.01% to 1%; most preferably from about 0.05% to about 0.30% by weight.

The packaging solution has a tonicity of from about 200 to about 450 milliosmol (mOsm), preferably from about 250 to about 350 mOsm. The tonicity of a packaging solution can be adjusted by adding organic or inorganic substances which affect the tonicity. Suitable occularly acceptable tonicity agents include, but are not limited to sodium chloride, potassium chloride, glycerol, propylene glycol, polyols, mannitols, sorbitol, xylitol and mixtures thereof.

Any materials, which can be hydrolyzed during autoclave to produce an acidic or base material, can be used as hydrolysable-at-autoclave material in the invention. Examples of preferred as hydrolysable-at-autoclave materials include without limitation urea, ammonium carbamate, water-soluble polyvinyl acetates, esters, anhydrides, and the like. Urea and ammonium carbamate can be hydrolyzed during autoclave to form ammonium as hydrolysis product to increase a solution's pH. Polyvinyl acetates, esters and anhydrides can be hydrolyzed during autoclave to form acid as hydrolysis product to decrease a solution's pH. The amount of the hydrolysable-at-autoclave material in the packaging solution should be sufficient to impart a final neutral pH (i.e., from about 6.0 to about 8.0) to the packaging solution after autoclave. According to the present invention, the amount of decomposable-at-autoclave material (hydrolysable-at-autoclave material) ranges preferably from 0.001% to 2%, preferably from 0.01% to 1%; most preferably from about 0.05% to about 0.30% by weight.

In an embodiment, the in-package-coating solution has an initial pH between 1 to 4.0, preferably, between 1.5 to 3, even more preferably between 2.2 to 2.8 and comprises a polyanionic material having a hydrophobic backbone and pendant ionizable groups, urea or ammonium carbamate as hydrolysable-at-autoclave material, and one water-soluble polymeric material comprising azetidinium groups. Preferably, the concentration of the polyanionic material is higher than that of the water-soluble polymeric material comprising azetidinium groups. Where the packaging solution has a low pH, the pendant ionizable groups of the polyanionic can be prevented from being ionized (i.e., becoming charged groups) and the hydrophobic-hydrophobic interactions between the hydrophobic backbone of the polyanionic material and the surface areas of a polyvinylalcohol-based hydrogel contact lens can be increased. It is believed that the polyanionic material to be deposited first onto the polyvinylalcohol-based hydrogel contact lens to form a layer and then the water-soluble polymeric material comprising azetidinium groups is bound to the layer of polyanionc material on the lens.

The in-package-coating solution preferably contains a buffering agent. The buffering agents maintain the pH preferably in the desired range after the lens is autoclaved, for example, in a physiologically acceptable range of from about 6.3 to about 7.8, preferably between 6.5 to 7.6, even more preferably between 6.8 to 7.4. Any known, physiologically compatible buffering agents can be used. Suitable buffering agents as a constituent of the packaging solution according to the invention are known to the person skilled in the art. Examples are: boric acid, borates, e.g. sodium borate, citric acid, citrates, e.g. potassium citrate, bicarbonates, e.g. sodium bicarbonate, phosphate buffers (e.g. Na₂HPO₄, NaH₂PO₄, Na₂HPO₄, and KH₂PO₄, TRIS (tris(hydroxymethyl)aminomethane), 2-bis(2-hydroxyethyl)amino-2-(hydroxymethyl)-1,3-propanediol, bis-aminopolyols, triethanolamine, ACES (N-(2-hydroxyethyl)-2-aminoethanesulfonic acid), BES (N,N-Bis(2-hydroxyethyl)-2-aminoethanesulfonic acid), HEPES (4-(2-hydroxyethyl)-1-piperazineethanesulfonic acid), MES (2-(N-morpholino)ethanesulfonic acid), MOPS 3-[N-morpholino]-propanesulfonic acid, PIPES (piperazine-N,N′-bis(2-ethanesulfonic acid), TES (N-[Tris(hydroxymethyl)methyl]-2-aminoethanesulfonic acid), and salts thereof. The amount of each buffer agent is that amount necessary to be effective in achieving a desired pH. Typically, it is present in an amount of from 0.001% to 2%, preferably from 0.01% to 1%; most preferably from about 0.05% to about 0.30% by weight.

The packaging solution is formulated in such a way that they are isotonic with the lachrymal fluid. A solution which is isotonic with the lachrymal fluid is generally understood to be a solution whose concentration corresponds to the concentration of a 0.7% to 0.9% sodium chloride solution.

The isotonicity with the lachrymal fluid, or even another desired tonicity, may be adjusted by adding organic or inorganic substances which affect the tonicity. Suitable occularly acceptable tonicity agents include, but are not limited to sodium chloride, potassium chloride, glycerol, sorbitol, xylitol, mannitol, propylene glycol, polyethylene glycol (PEG) with a molecular weight of about 400 Da or less, and mixtures thereof. The tonicity of the solution is typically adjusted to be in the range from about 200 to about 450 milliosmol (mOsm), preferably from about 200 to 450 mOsm, preferably from about 250 to 350 mOsm.

In accordance with the present invention, first step, an in-package-coating solution can be prepared in a variety of ways. For example, preferably, a polyanionic material solution can be formed by dissolving a polyanionic material in water. Once dissolved, the pH of the polyanionic material solution is adjusted to a desired pH (e.g. 1-4), preferably pH about 2, by adding an acid such as HCL. On the other hand, second step, an in-package-saline solution is prepared by adding desirable amount polyamidoamine-epichlorohydrin (PAE) and a desirable type and amount of hydrophilicity-enhancing agent in a buffer solution, for example, a Phosphate buffered saline (PBS) and adjust the pH to 7.2-7.4. The desirable amount polyamidoamine-epichlorohydrin (PAE) and the desirable type and amount of hydrophilicity-enhancing agent are as disclosed previously in this patent application. For example, the hydrophilicity-enhancing agent can be polyacrylamide-poly (acrylic acid) (PAAm-PAA) copolymer. Then the in-package-saline solution is heat pre-reacted for about 0.3 hours even more preferably from about 2 hours to about 12 hours to form water-soluble and thermal-crosslinkable hydrophilic polymeric material azetidinium groups. After pre-reaction, the saline is cooled down to room temperature. Then, for the third step, mix the in-package-saline solution with the polyanionic material solution. The volume ratio of the polyanionic material solution/in-package-saline solution is chosen to achieve a molar charge ratio of the polyanionic material to the thermal-crosslinkable hydrophilic polymeric material azetidinium groups ranges preferably from 1:100 to 100:1. The pH of the mixture is adjusted to a desired pH (e.g. 1-4), preferably pH about 2. Fourth step, a hydrolysable-at-autoclave material and a tonicity agent is added to the mixture of polyanionic material solution and the in-package-saline solution to form an in-package-coating solution. Please note the above sequence of steps for preparing an in-package-coating solution is just for illustration purpose. Many different sequence of step can be chosen to achieve the desired results. For example, a hydrolysable-at-autoclave material and/or a tonicity agent can be added to the polyanionic material solution.

A polyvinylalcohol-based hydrogel contact lens can be simple immersed in the in-package-coating solution, sealed and autoclaved at a condition disclosed above in the present application.

“The concentration of the water-soluble and thermally-crosslinkable hydrophilic polymeric material having azetidinium groups in an in-package-coating solution can generally vary depending on the particular materials being utilized, the desired coating thickness, and a number of other factors. It may be typical to formulate a relatively dilute aqueous solution of a coating material. In a preferred embodiment, the in-package-coating solution comprises preferably from about 0.01% to about 4%, more preferably from about 0.05% to about 3%, even more preferably from about 0.1% to about 2%, most preferably from about 0.1% to about 1%, by weight of the water-soluble and thermally-crosslinkable hydrophilic polymeric material having azetidinium groups of the invention.

In order to alter various characteristics of the coating, such as thickness, the molecular weight of the coating materials can be varied. In particular, as the molecular weight is increased, the coating thickness generally increases.

In another aspect, the invention provides a method for applying an ophthalmic product having a lubricious surface, comprising the steps of:
(1) obtaining a polyvinylalcohol-based hydrogel contact lens,
(2) placing the polyvinylalcohol-based hydrogel contact lens in a lens package containing an polyanionic polymer solution for more than 10 seconds to form a layer of the polyanionic polymer coating on the hydrogel contact lens, wherein the polyanionic polymer having carboxyl groups and the solution having a pH of 1.0 to 4.0, and then
(3) adding a water-soluble and thermal-crosslinkable polymeric material comprising azetidinium groups to the lens package of the step (2) containing the polyanionic polymer solution to form an in-package-coating solution, provided that the molar charge ratio of the polyanionic polymer and the water-soluble and thermal-crosslinkable polymeric material comprising azetidinium groups is from 1:100 to 100:1 and no precipitation is formed after mixing, wherein the in-package-coating solution having a pH higher than 6,
(4) sealing the lens package with the contact lens and the in-package-coating solution,
(5) autoclaving said package with the contact lens and the in-package-coating solution therein, thereby inducing crosslinking reaction between azetidinium groups of the water-soluble and thermal-crosslinkable polymeric material and the carboxyl groups of the polyanionic polymer to form an in-package crosslinked hydrophilic coating on the surface of the polyvinylalcohol-based hydrogel contact lens, wherein the polyvinylalcohol-based hydrogel contact lens with the crosslinked hydrophilic coating thereon has a surface having improved lubricity as compared to uncoated lenses.

In this aspect of the invention, there is no need to add at least one decomposable at-autoclave material. In this aspect of the invention, a polyvinylalcohol-based hydrogel contact lens is simply immersed in a lens package (a vial or a blister) containing an polyanionic polymer solution for a period of time sufficiently to form a layer of the polyanionic polymer coating on the hydrogel contact lens, wherein the polyanionic polymer having carboxyl groups and the solution having a pH of 1.0 to 4.0. It may be typical to formulate a relatively dilute aqueous solution of a polyanionic polymer material. For example, a polyanionic polymer coating material concentration can be between about 0.0001% to about 1% by weight, between about 0.005% to about 0.5% by weight, or between about 0.01% to about 0.1% by weight. The period of time for immersing the hydrogel lens in the lens package containing a polyanionic polymer solution ranges from 1 second to 6 hours, more preferably from 3 seconds to 30 minutes, even more preferably from 4 seconds to 20 minutes, most preferably from 5 seconds to 15 minutes. In this aspect of the invention, the in-package-coating solution having appropriate osmolarity and a preferably pH higher than 6, more preferably higher than 7, even more preferably higher than 8, most preferably equal to 9 or higher than 9 by adding appropriate amount of diluted NaOH solution before the use. A person of skill in the art knows how to select the pH for the in-package-coating solution for this aspect of the invention to achieve a pH of the in-package-coating solution around 7 after autoclave and also appropriate osmolarity (e.g. around 300 mOsm) after autoclave.

Above described various embodiments and preferred embodiments of packages, coating techniques, coating materials, and coating temperature can be used in this aspect of the invention.

The previous disclosure will enable one having ordinary skill in the art to practice the invention. In order to better enable the reader to understand specific embodiments and the advantages thereof, reference to the following examples is suggested.

### Example 1

### Lubricity Evaluation.

The lubricity of a contact lens is evaluated by using a finger-felt lubricity test which characterizes qualitatively the slipperiness of a lens surface on a friction rating scale of from 0 to 4. The higher the friction rating is, the lower the slipperiness (or lubricity).

Commercial lenses: DAILIES® TOTAL1®; ACUVUE® OASYS™; ACUVUE® ADVANCE PLUS™; DAILIES® Aqua Comfort Plus®; and AIR OPTIX®, are assigned a friction rating (designated “FR” hereinafter) of 0, 1, 2, 3, and 4 respectively. They are used as standard lenses for determining the friction rating of a lens under test.

The samples are placed in PBS for at least two rinses of 30 minutes each and then transferred to fresh PBS before the evaluation. Before the evaluation, hands are rinsed with a soap solution, extensively rinsed with DI water and then dried with KimWipe® towels. The samples are handled between the fingers and a numerical number is assigned for each sample relative to the above standard lenses described above. For example, if lenses are determined to be only slightly better than AIR OPTIX® lenses, then they are assigned a number 3. The value of a friction rating is one obtained by averaging the results of at least two friction ratings of a contact lens by two or more persons and/or by averaging the friction ratings of two or more contact lenses (from the identical batch of lens production) by one person.

The finger lubricities (i.e., friction ratings) of a contact lens can be determined either directly out-of-pack (OOP) but after 30 min soaking in PBS) or after i cycles (e.g., 7, 14, 21, or 30 cycles) of digital rubbing according to the procedures described above.

### Surface Wettability Tests

Water contact angle (WCA) on a contact lens is a general measure of the surface wettability of a contact lens. In particular, a low water contact angle corresponds to more wettable surface. The dynamic captive bubble contact angles of contact lenses are measured using a FDS instrument device from FDS Future Digital Scientific Corp. The FDS equipment is capable of measuring the advancing and receding contact angles. The measurement is performed on hydrated contact lenses at room temperature. A contact lens is removed from the vial and soaked in ˜40 mL fresh PBS and shake for at least 30 minutes, then replace with fresh PBS, soak and shake for another 30 minutes unless otherwise specified. The contact lens is then put on a lens paper and dabbed to remove surface water prior to be placed on top of a lens holder with front curve up then screw the lens holder top on. Place the secure lens holder into the glass cell cuvette filled with filtered PBS. Place the glass cell cuvette onto the stage of the FDS instrument. Adjust the stage height and the syringe needle to dispense the air bubble to the lens surface. Repeat dispense/withdrawal 3 cycles for every lens to get the advancing and receding contact angles. The receding contact angles are reported in the examples below.

Coating Intactness Tests. The intactness of a coating on the surface of a contact lens can be tested according to Sudan Black stain test as follow. Contact lenses with a coating (an LbL coating, a plasma coating, a hydrogel coating, or any other coatings) are dipped into a Sudan Black dye solution (Sudan Black in the mixture ˜80% mineral oil and ˜20% vitamin E oil). Sudan Black dye is hydrophobic and has a great tendency to be adsorbed by a hydrophobic material or onto a hydrophobic lens surface or hydrophobic spots on a partially coated surface of a hydrophobic lens (e.g., silicone hydrogel contact lens). If the coating on a hydrophobic lens is intact, no staining spots should be observed on or in the lens. The SBQ (Sudan Black Quantifier) is a custom-made Matlab program that images each SB stained lens in a cuvette under consistent lighting condition. Based upon the grayscale value of the each pixel, a pixel is “stained” when the grayscale value exceeds a predetermined value (180 out of 255 grayscale value). The ratio of “stained pixels” count over the total pixel count from the lens is reported as the SBQ value, which can be thought of as a percentage of the lens stained area.

### Lens Surface FSI Test.

### Front Surface Imperfection (FSI) Test is the Tork Debris Adhesion Evaluation.

The Tork Debris Adhesion Evaluation method is used to differentiate the amount of debris left behind on contact lenses after exposure to hands washed and then dried with Tork Premium paper towels. The data generated from this method serve as an informational tool to assess the relative susceptibility of the lens to the adherence of non-specific debris from the Tork towels. The method does not set or imply specifications for pass/fail or acceptable/unacceptable levels of debris adhesion. This method is qualitative and is intended for evaluating development lenses only.

The debris adhesion rating scale is a five point scale with integer values from 0 and 4.0 is the best rating. 4 is the worst rating. Contact lenses coated with PAA/1-PrOH and handled with hands washed and then dried with the Tork Premium paper towels are generally representative of level 4 debris adhesion. The rating scale is correlated with the number of large globular like particles on a lens's surface. As the number of particles on a lens increases the debris adhesion grade of that lens increases. Lenses exhibiting FSI=0-1 are considered better and are expected to exhibit no extra negative charge on lens surface.

Tests of Lenses with Contact Lens Analyzer at Low pH (Low pH CLAN).

Low pH CLAN tests for the coating coverage on lens surfaces using a hydrophobic (Nile red, also known as Nile Blue Oxazone) dye. Any exposed hydrophobic areas on the lens will bind hydrophobic dye. If a homogeneous coating on the lens is intact, no staining spots should be observed on or in the lens. The test is done by dipping a contact lens into 1N HCl(aq) for about 30 seconds, followed by a 2 second dip in a Nile red solution (1-propanol/n-Heptane), and finally a 30 second dip in DI water to rinse off the excess dye. The lens is then placed in the CLAN (digital camera at a fixed focus through a magnifying optics and filter) where the lens is then illuminated with the blue fluorescence excitation light. The image is captured and analyzed by image processing software for the hydrophobic fluorescence dye adsorbed by the hydrophobic surfaces. The lens is considered a failure if the sum of half the number of light pixels and half the number of dark pixels is greater than 5000.

### Chemicals

The following abbreviations are used in the following examples: PAA represents polyacrylic acid; PAE represents polyamidoamine-epichlorohydrin (a.k.a., polyamine-epichlorohydrin); MPC represent 2-methacryloyloxyethyl phosphorylcholine; Poly(AAm-co-AA) represents poly(acrylamide-co-acrylic acid);

### Example 2

### IPC Saline #0

IPC saline is prepared by dissolving/mixing appropriate amounts of Poly(AAm-co-AA)(90/10), PAE, NaH₂PO4.H₂O, Na₂HPO₄.2H₂O and NaCl in DI (de-ionized) water to have the following concentrations: about 0.07 wt. % of poly(AAm-co-AA); about 0.11 wt. % PAE; about 0.044 wt. % NaH₂PO4.H₂O, about 0.388 wt. % Na₂HPO₄.2H₂O, and about 0.79 wt. % NaCl and then by adjusting pH to about 7.3. The prepared solution is pre-treated at 65° C. for about 6 hours. After the heat pre-treatment, the IPC saline is cooled down back to room temperature. Up to 5 ppm hydrogen peroxide maybe added to the final IPC saline to prevent bioburden growth and the IPC saline is filtered using a 0.22 micron membrane filter.

### Phosphate Buffered Saline (PBS)

A phosphate buffered saline is prepared by dissolving NaH₂PO₄.H₂O, Na₂HPO₄.2H₂O, and in a given volume of purified water (distilled or deionized) to have the following composition: ca. 0.044 w/w % NaH₂PO₄.H₂O, ca. 0.388 w/w/% Na₂HPO₄.2H₂O, and ca. 0.79 w/w % NaCl.

### IPC Saline #1 (Saline 4C):

Saline is prepared from polyamidoamine-epichlorohydrin (PAE) and mono-thiol-terminated and monomethyl-terminated polyethylene glycol (i.e., mPEG-SH). It is prepared as following: (1) dissolve ca. 17.3 w/w % PAE into ca. 72.2 w/w % PBS; (2) 7.5 w/w % sodium citrate dihydrate and 3 w/w % mPEG-SH are added to solution (the concentration of mPEG-SH and PAE are about 30 times of final IPC saline); (3) after stirring for about 5 min, pH of solution is adjusted to ˜7.5 by adding 1N NaOH; (4) solution is then purged with N₂ (flow rate 0.1 SCFhr) for 30 minutes to 1 hour usually at room temperature; (5) react the mixture in a water bath at 45° C. for 6 hours; (6) remove the mixture from water bath and cool down in a room temperature water bath; (7) dilute the mixture with PBS (30 times dilution) and adjust pH to ˜7.2; and (8) filter the mixture by 0.22 μm PES sterile filter unit.

### IPC Saline #2

IPC saline is prepared by dissolving/mixing appropriate amounts of Poly(AAm-co-AA)(90/10), PAE, NaH₂PO4.H₂O, Na₂HPO₄.2H₂O in DI (de-ionized) water to have the following concentrations: about 0.28 wt. % of poly(AAm-co-AA); about 0.025 wt. % PAE; about 0.044 wt. % NaH₂PO4.H₂O, about 0.388 wt. % Na₂HPO₄.2H₂O and then by adjusting pH to about 7.3. Poly(AAm-co-AA)(90/10) partial sodium salt, poly(AAm-co-AA) 90/10, Mw 200,000) is purchased from Polysciences, Inc. and used as received. The prepared solution is pre-treated at 60° C. for about 6 hours. After the heat pre-treatment, the IPC saline is cooled down back to room temperature. 2.2 wt. % C₃H₈O₃ is added to the final IPC saline and then adjust the pH to about 7.3. Up to 5 ppm hydrogen peroxide maybe added to the final IPC saline to prevent bioburden growth. The IPC saline is filtered using a 0.22 micron membrane filter.

### IPC Saline #3

This IPC saline is prepared by dissolving/mixing appropriate amounts of poly(MPC-co-AEM), PAE, NaH2PO4.H2O and Na2HPO4.2H2O in DI (de-ionized) water to have the following

concentrations: about −5.6 wt. % poly(MPC-co-AEM); about 0.92 wt. % PAE; about 0.046 wt. %

NaH2PO4.H2O, about 0.19 wt. % Na2HPO4.2H2O, about 0.77 st % NaCl and then by adjusting pH to about 7.3. The prepared solution is pre-treated at 65° C. for about 4.5 hours. After the heat pre-treatment, the IPC saline is cooled down back to room temperature and then is diluted to a final solution that has ˜0.75 wt % poly(MPC-co-AEM); about 0.12 wt % PAE; about 0.074 wt. % NaH2PO4.H2O, about 0.30 wt. % Na2HPO4.2H2O, 0.070% sodium citrate dihydrate and about 0.77 wt. % NaCl. Then the pH is adjusted to about 7.3. The IPC saline is filtered using a 0.22 micron membrane filter.

### Preparation of PAA Stock Solution

A PAA stock solution was prepared by dissolving a PAA concentrate in water, glycerol, formic acid (or replaced by 5N HCl for pH adjustment), urea, and water at a determined final concentration (specified in the table).

### Preparation of Final Saline Solution

Mix designated IPC saline dropwise to target weight of PAA stock solution until mixture becomes slightly hazy. The final mixture is filtered using a 0.22 micron membrane filter.

### Lens Preparation

Sample lenses was prepared by the following steps (1) remove Daily Aqua Comfort Plus lenses (a commercial available from ALCON, is a polyvinylalcohol-based hydrogel contact lens, basically manufactured according to U.S. Pat. No. 8,030,369 from blister, (2) soak lenses in PBS saline, (3) package the lens with various IPC salines, (4) autoclave at 121° C. for 45 minutes

| | | | Formic | | pH of the | Osmo | | |
|---|---|---|---|---|---|---|---|---|
| | PAA | Glycerin | Acid | Urea | mixture before | after AC | pH after AC | Lubricity |
| Soln. ID | (wt %) | (wt %) | (wt %) | (wt %) | Autoclave (AC) | (with lens) | (no lens) | & FSI |
| PAA#1 | 0.1 | 1.5 | 1.87 | 0.3 | 2.22 | 824 | 2.90 | 0, 0 |
| | | | | | | | | FSI: 4, 4, |
| | | | | | | | | 4 |
| PAA#2 | 0.05 | 1 | 0.5 | 0.3 | 2.76 | NA | NA | NA |
| PAA#3 | 0.01 | 1 | 0.5 | 0.3 | 2.75* | NA | NA | NA |
| PAA#4 | 0.05 | 0.2 | 0.5 | 1.3 | 2.76** | NA | NA | NA |
| PAA#5 | 0.05 | 0.2 | None | 0.2 | 2.80*** | NA | NA | NA |
| PAA#6 | 0.05 | 2 | None | 0.15 | 2.85*⁽⁴⁾ | NA | NA | NA |

| | | | | | |
|---|---|---|---|---|---|
| Ex2-1 | 50.01 gram PAA#1 + 0.3522 grams | 2.80 | 856 | 3.19 | 0, 0 |
| | IPC saline#0 + 1N NaOH | | | | |
| Ex2-2 | 100 gram PAA#2 + 0.9303 gram | 2.80 | 433 | 3.70 | 0, 0 |
| | IPC saline#0 | | | | |
| Ex2-3 | 100 gram PAA#3 + 1.1315 gram | 2.74 | 330 | 3.73 | 3, 3 |
| | IPC saline#0 | | | | |
| Ex2-4 | 100 gram PAA#4 + 1.6063 gram | 2.79 | 528 | 6.57 | 0, 0 |
| | IPC saline#0 | | | | FSI: 2 |
| Ex2-5 | 100 gram PAA#4 + 3.7926 gram | 2.79 | 529 | 6.41 | 0.5, 0.5 |
| | IPC saline#1 | | | | FSI: 0 |
| Ex2-6 | 100 gram PAA#5 + 1.0746 gram | 2.72 | 176 | 7.54 | 0, 0 |
| | IPC saline#0 | | | | FSI: 1~2 |
| Ex2-7 | 100 gram PAA#5 + 0.9321 gram | 2.74 | 182 | 7.63 | 0, 0 |
| | IPC saline#1 | | | | FSI: 2~3 |
| Ex2-8 | 100 gram PAA#6 + 0.9604 gram | 2.77 | 362 | 7.28 | 0, 0 |
| | IPC saline#0 | | | | FSI: 0~0.5 |
| Ex2-9 | 100 gram PAA#6 + 3.5331 gram | 2.80 | 366 | 7.19 | 0, 0 |
| | IPC saline#2 | | | | FSI: 0~0.5 |

*pH adjusted from 2.64 to 2.75 by 1N NaOH
**pH adjusted from 2.36 to 2.76 by 1N NaOH
***pH adjusted from 3.83 to 2.80 by 5N HCl
*⁽⁴⁾pH adjusted from 3.68 to 2.85 by 5N HCl

### Example 3

Extend similar experiments, but replace formic acid by 5N HCl for pH adjustment and add phosphate buffer in PAA stock solution. Phosphate buffer preparation as following:
10 mM: dissolving ca 0.037% NaH₂PO4.H₂O, and ca. 0.13% Na₂HPO₄.2H₂O, in purified water
20 mM: dissolving ca 0.074% NaH₂PO4.H₂O, and ca. 0.26% Na₂HPO₄.2H₂O, in purified water

| | | | | | pH of | | | |
|---|---|---|---|---|---|---|---|---|
| | | | | | the | Osmo | pH after | |
| | | | | | mixture | after AC | AC | Lubricity & |
| | PAA | Glycerin | [PB] | Urea | before | (with | (with | Low pH |
| Soln. ID | (wt %) | (wt %) | (mM) | (wt %) | AC | lens) | lens) | CLAN |
| PAA#7 | 0.05 | 1.2 | 10 | 0.2 | 2.81 | 309 | 6.89 | 0.5, 0.5 |
| | | | | | | | | CLAN = PASS |
| PAA#8 | 0.05 | 1.0 | 10 | 0.5 | 2.82 | NA | NA | NA |
| PAA#9 | 0.05 | 1.2 | 20 | 0.2 | 2.82 | 352 | 6.64 | 0.5, 0.5 |
| | | | | | | | | CLAN = PASS |

| | | | | | |
|---|---|---|---|---|---|
| Ex3-1 | 100 gram PAA#7 + 0.9935 gram | 2.78 | 301 | 6.92 | 0.5, 0.5 |
| | of IPC Saline#0 | | | | CLAN = PASS |
| Ex3-2 | 100 gram PAA#7 + 1.0330 gram | 2.79 | 341 | 7.62 | 0.5, 0.5 |
| | of IPC Saline#0 | | | | CLAN = PASS |
| Ex3-3 | 100 gram PAA#7 + 1.0348 gram | 2.84 | 340 | 6.70 | 0.5, 0.5 |
| | of IPC Saline#0 | | | | CLAN = PASS |

### Example 4

Apply similar experiment on Acuvue 2 lens (commercially available from J&J) (i.e., replace DACP lens by Acuvue 2 which represents HEMA based)

| | | | | | | Osmo | | |
|---|---|---|---|---|---|---|---|---|
| | | | | | pH of the | after AC | pH after | |
| | PAA | Glycerin | [PB] | Urea | mixture | (with | AC | |
| Soln. ID | (wt %) | (wt %) | (mM) | (wt %) | before AC | lens) | (with lens) | Lubricity |
| PAA#8 | 0.05 | 1.5 | 10 | 0.2 | 2.83 | NA | NA | NA |

| | | | | | |
|---|---|---|---|---|---|
| Ex4-1 | 100 gram PAA#8 + 1.0782 gram of | 2.81 | 358 | 7.18 | 3, 3 |
| | IPC Saline#0 | | | | |

### Example 5

Tonacity agent was replaced from glycerin to NaCl.

| | | | | | pH of the | Osmo after | | Lubricity & |
|---|---|---|---|---|---|---|---|---|
| | PAA | NaCl | [PB] | Urea | mixture | AC | pH after AC | Low pH |
| Soln. ID | (wt %) | (wt %) | (mM) | (wt %) | before AC | (with lens) | (with lens) | CLAN |
| PAA#9 | 0.05 | 0.5 | 10 | 0.3 | 2.82 | NA | NA | NA |
| PAA#10 | 0.05 | 0.3 | 20 | 0.5 | 2.83 | NA | NA | NA |

| | | | | | |
|---|---|---|---|---|---|
| Ex5-1 | 100 gram PAA#9 + 2 gram | 2.80 | 264 | 7.50 | 3, 3 |
| | of IPC Saline#0 | | | | CLAN: PASS |
| Ex5-2 | 100 gram PAA#10 + 2 gram | 2.79 | 269 | 7.49 | 1, 1 |
| | of IPC Saline#0 | | | | CLAN: PASS |

The solution PAA #9 and PAA #10 after autoclave was stored at room temperature and pH was monitored as shown below:

| | Timing (day) | | | | | | |
|---|---|---|---|---|---|---|---|
| | 1 | 2 | 3 | 7 | 15 | 37 | 90 |
| PAA#9 | 7.02 | 7.03 | 7.04 | 7.00 | 7.08 | 7.01 | 7.04 |
| PAA#10 | 7.04 | 7.05 | 7.06 | 7.01 | 7.05 | 7.02 | 7.02 |

### Example 6

Continue on Example 5 to improve lubricity by lowering the mixture pH before autoclave with DACP lens.

| | | | | | | Osmo | pH after | | |
|---|---|---|---|---|---|---|---|---|---|
| | | | | | pH of the | after AC | AC | | |
| | PAA | NaCl | [PB] | Urea | mixture | (with | (with | Lubricity & | Contact |
| Soln. ID | (wt %) | (wt %) | (mM) | (wt %) | before AC | lens) | lens) | FSI | angle (°) |
| PAA#11 | 0.05 | 0.6 | 10 | 0.3 | 2.50 | 298 | 7.25 | 0, 0 | 22 ± 2 |
| | | | | | | | | FSI: 0~0.5 | |
| PAA#12 | 0.10 | 0.6 | 10 | 0.5 | 2.51 | 294 | 7.04 | 0, 0 | 20 ± 2 |
| | | | | | | | | FSI: 0.5~1 | |

| | | | | | | |
|---|---|---|---|---|---|---|
| Ex6-1 | 100 gram PAA#11 + 2 gram of | 2.45 | 304 | 7.13 | 0, 0 | 22 ± 2 |
| | IPC Saline#0 | | | | FSI: 0~0.5 | |
| Ex6-2 | 100 gram PAA#12 + 2 gram of | 2.46 | 300 | 7.05 | 0, 0 | 21 ± 2 |
| | IPC Saline#0 | | | | FSI: 0~0.5 | |

What is claimed is:

1. A method for applying an ophthalmic product having a lubricious and wettable surface, comprising the steps of:
(1) obtaining a polyvinylalcohol-based hydrogel contact lens,
(2) placing the polyvinylalcohol-based hydrogel contact lens in a lens package containing an in-package-coating solution, wherein the in-package-coating solution comprises:
(A) a polyanionic polymer having carboxyl groups,
(B) Prefer at least one water-soluble and thermally-crosslinkable polymeric material comprising azetidinium groups,
(C) at least one decomposable-at-autoclave material, wherein the in-package-coating solution has a pH of from about 1.0 to about 4.0, provided that the molar charge ratio of the polyanionic polymer and the water-soluble and thermal-crosslinkable polymeric material comprising azetidinium groups is from 1:100 to 100:1 and no precipitation is formed after mixings, wherein the polyanionic polymer attaching and forming at least one layer coating on the surface of the polyvinylalcohol-based hydrogel contact lens,
(3) sealing the lens package with the contact lens and the in-package-coating solution having the pH of from about 1.0 to about 4.0,
(4) autoclaving said package with the contact lens and the in-package-coating solution therein, thereby inducing crosslinking reaction between azetidinium groups of the water-soluble polymeric material and the carboxyl groups of the polyanionic polymer to form a crosslinked hydrophilic coating on the surface of the polyvinylalcohol-based hydrogel contact lens immersed in the in-package-coating solution, wherein the decomposable-at-autoclave material is hydrolyzed to increase the pH to 6.5 to 7.5, wherein the polyvinylalcohol-based hydrogel contact lens with the crosslinked hydrophilic coating thereon has a surface having improved lubricity as compared to uncoated lenses.

2. The method of claim 1, wherein the polyvinylalcohol-based hydrogel contact lens is composed of a polymer comprising at least 50% by mole of repeating units of vinyl alcohol,

3. The method of claim 1, wherein the decomposable-at-autoclave material is urea, ammonium carbamate, or combination thereof.

4. The method of claims 1 and 2, wherein the water-soluble and thermally-crosslinkable polymeric material comprises (i) from about 20% to about 95% by weight of first polymer chains derived from an epichlorohydrin-functionalized polyamine or polyamidoamine, (ii) from about 5% to about 80% by weight of hydrophilic moieties or second polymer chains derived from at least one hydrophilicity-enhancing agent having at least one reactive functional group selected from the group consisting of amino group, carboxyl group, and combination thereof.

5. The method of claim 4, wherein the hydrophilic polymer as the hydrophilicity-enhancing agent is a copolymer which is a polymerization product of a composition comprising (1) about 60% by weight or less by weight of at least one reactive vinylic monomer and (2) at least one non-reactive hydrophilic vinylic monomer and/or at least one phosphorylcholine-containing vinylic monomer; or combinations thereof;
wherein the reactive vinylic monomer is selected from the group consisting of amino-C₁-C₆ alkyl (meth)acrylate, C₁-C₆ alkylamino-C₁-C₆ alkyl (meth)acrylate, allylamine, vinylamine, amino-C₁-C₆ alkyl (meth)acrylamide, C₁-C₆ alkylamino-C₁-C₆ alkyl (meth)acrylamide, acrylic acid, C₁-C₁₂ alkylacrylic acid, N,N-2-acrylamidoglycolic acid, beta-methyl-acrylic acid, alpha-phenyl acrylic acid, beta-acryloxy propionic acid, sorbic acid, angelic acid, cinnamic acid, 1-carobxy-4-phenyl butadiene-1,3, itaconic acid, citraconic acid, mesaconic acid, glutaconic acid, aconitic acid, maleic acid, fumaric acid, tricarboxy ethylene, and combinations thereof;
wherein the non-reactive hydrophilic vinylic monomer is selected from the group consisting of acrylamide, methacrylamide, N,N-dimethylacrylamide, N,N-dimethylmethacrylamide, N-vinylpyrrolidone, N,N,-dimethylaminoethylmethacrylate, N,N-dimethylaminoethylacrylate, N,N-dimethylaminopropylmethacrylamide, N,N-dimethylaminopropylacrylamide, glycerol methacrylate, 3-acryloylamino-1-propanol, N-hydroxyethyl acrylamide, N-[tris(hydroxymethyl)methyl]-acrylamide, N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 2-hydroxyethyl (meth)acrylate, hydroxypropyl (meth)acrylate, C₁-C₄-alkoxy polyethylene glycol (meth)acrylate having a weight average molecular weight of up to 1500 Daltons, N-vinyl formamide, N-vinyl acetamide, N-vinyl isopropylamide, N-vinyl-N-methyl acetamide, allyl alcohol, vinyl alcohol (hydrolyzed form of vinyl acetate in the copolymer), and combinations thereof.

6. The method of claim 4, wherein the weight average molecular weight M_{w} of the hydrophilic polymer as the hydrophilicity-enhancing agent is from about 500 to about 1,000,000.

7. The method of claim 1, wherein the step of autoclaving is performed by heating the polyvinylalcohol-based hydrogel contact lens immersed in a packaging solution in a sealed lens package at a temperature of from about 118° C. to about 125° C. for approximately 20-90 minutes to form the crosslinked hydrophilic coating on the polyvinylalcohol-based hydrogel contact lens, wherein the packaging solution comprises at least one buffering agent in an amount sufficient to maintain a pH of from about 6.0 to about 8.5 and has a tonicity of from about 200 to about 450 milliosmol (mOsm) and a viscosity of from about 1 centipoise to about 20 centipoises at 25° C.

8. The method of claim 4, wherein the molar charge ratio of the polyanionic material to the water soluble and thermal-crosslinkable hydrophilic polymeric material azetidinium groups is from 1:20 to 20:1.

9. A method for applying an ophthalmic product having a lubricious surface, comprising the steps of:
(1) obtaining a polyvinylalcohol-based hydrogel contact lens,
(2) placing the polyvinylalcohol-based hydrogel contact lens in a lens package containing an polyanionic polymer solution for more than 10 seconds to form a layer of the polyanionic polymer coating on the hydrogel contact lens, wherein the polyanionic polymer having carboxyl groups and the solution having a pH of 1.0 to 4.0, and then
(3) adding a water-soluble and thermal-crosslinkable polymeric material comprising azetidinium groups to the lens package of the step (2) containing the polyanionic polymer solution to form an in-package-coating solution, provided that the molar charge ratio of the polyanionic polymer and the water-soluble and thermal-crosslinkable polymeric material comprising azetidinium groups is from 1:100 to 100:1 and no precipitation is formed after mixing, wherein the in-package-coating solution having a pH higher than 6,
(4) sealing the lens package with the contact lens and the in-package-coating solution,
(5) autoclaving said package with the contact lens and the in-package-coating solution therein, thereby inducing crosslinking reaction between azetidinium groups of the water-soluble and thermal-crosslinkable polymeric material and the carboxyl groups of the polyanionic polymer to form an in-package crosslinked hydrophilic coating on the surface of the polyvinylalcohol-based hydrogel contact lens, wherein the polyvinylalcohol-based hydrogel contact lens with the crosslinked hydrophilic coating thereon has a surface having improved lubricity as compared to uncoated lenses.

10. The method of claim 9, wherein the polyvinylalcohol-based hydrogel contact lens is composed of a polymer comprising at least 50% by mole of repeating units of vinyl alcohol.

11. The method of claims 9 and 10, wherein the water-soluble and thermally-crosslinkable polymeric material comprises (i) from about 20% to about 95% by weight of first polymer chains derived from an epichlorohydrin-functionalized polyamine or polyamidoamine, (ii) from about 5% to about 80% by weight of hydrophilic moieties or second polymer chains derived from at least one hydrophilicity-enhancing agent having at least one reactive functional group selected from the group consisting of amino group, carboxyl group, and combination thereof.

12. The method of claim 11, wherein the hydrophilic polymer as the hydrophilicity-enhancing agent is a copolymer which is a polymerization product of a composition comprising (1) about 60% by weight or less by weight of at least one reactive vinylic monomer and (2) at least one non-reactive hydrophilic vinylic monomer and/or at least one phosphorylcholine-containing vinylic monomer; or combinations thereof;
wherein the reactive vinylic monomer is selected from the group consisting of amino-C₁-C₆ alkyl (meth)acrylate, C₁-C₆ alkylamino-C₁-C₆ alkyl (meth)acrylate, allylamine, vinylamine, amino-C₁-C₆ alkyl (meth)acrylamide, C₁-C₆ alkylamino-C₁-C₆ alkyl (meth)acrylamide, acrylic acid, C₁-C₁₂ alkylacrylic acid, N,N-2-acrylamidoglycolic acid, beta-methyl-acrylic acid, alpha-phenyl acrylic acid, beta-acryloxy propionic acid, sorbic acid, angelic acid, cinnamic acid, 1-carobxy-4-phenyl butadiene-1,3, itaconic acid, citraconic acid, mesaconic acid, glutaconic acid, aconitic acid, maleic acid, fumaric acid, tricarboxy ethylene, and combinations thereof;
wherein the non-reactive hydrophilic vinylic monomer is selected from the group consisting of acrylamide, methacrylamide, N,N-dimethylacrylamide, N,N-dimethylmethacrylamide, N-vinylpyrrolidone, N,N,-dimethylaminoethylmethacrylate, N,N-dimethylaminoethylacrylate, N,N-dimethylaminopropylmethacrylamide, N,N-dimethylaminopropylacrylamide, glycerol methacrylate, 3-acryloylamino-1-propanol, N-hydroxyethyl acrylamide, N-[tris(hydroxymethyl)methyl]-acrylamide, N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 2-hydroxyethyl (meth)acrylate, hydroxypropyl (meth)acrylate, C₁-C₄-alkoxy polyethylene glycol (meth)acrylate having a weight average molecular weight of up to 1500 Daltons, N-vinyl formamide, N-vinyl acetamide, N-vinyl isopropylamide, N-vinyl-N-methyl acetamide, allyl alcohol, vinyl alcohol (hydrolyzed form of vinyl acetate in the copolymer), and combinations thereof.

13. The method of claim 11, wherein the weight average molecular weight Mw of the hydrophilic polymer as the hydrophilicity-enhancing agent is from about 500 to about 1,000,000.

14. The method of claim 9, wherein the step of autoclaving is performed by heating the polyvinylalcohol-based hydrogel contact lens immersed in a packaging solution in a sealed lens package at a temperature of from about 118° C. to about 125° C. for approximately 20-90 minutes to form the crosslinked hydrophilic coating on the polyvinylalcohol-based hydrogel contact lens, wherein the packaging solution comprises at least one buffering agent in an amount sufficient to maintain a pH of from about 6.0 to about 8.5 and has a tonicity of from about 200 to about 450 milliosmol (mOsm) and a viscosity of from about 1 centipoise to about 20 centipoises at 25° C.

15. The method of claim 11, wherein the molar charge ratio of the polyanionic material to the water soluble and thermal-crosslinkable hydrophilic polymeric material azetidinium groups is from 1:20 to 20:1.
